(19) United States
(12) Patent Application Publication
(10) Pub. No.: US 2022/0068113 A1
(43) Pub. Date: Mar. 3, 2022

(54) Forget Me Not Alarm

(71) Applicant: Emily Hossann, (US)

(72) Inventor: Emily Hossann, Sparrowbush, NY (US)

(73) Assignee: Emily Hossann, Sparrowbush, NY (US)

(21) Appl. No.: 17/362,538

(22) Filed: Jun. 29, 2021

Related U.S. Application Data
(60) Provisional application No. 63/071,391, filed on Aug. 28, 2020.

(51) Int. Cl. G08B 21/24; G08B 21/02; G08B 3/10

(52) U.S. Cl. CPC G08B 21/24; G08B 3/10; G08B 21/0288; G08B 21/0286

(57) ABSTRACT

A flower shaped child alarm system is disclosed herein including a reminder alarm assembly featuring a generally flower shaped flower head section having a speaker at a center portion, a suction cup, and a magnet release wire including a magnet extending therefrom. Additionally, a holster member is provided including a hook for mounting to an air vent of a vehicle and supporting the flower head section between uses. The holster member includes a magnet rest configured to removably attach to the magnet of the magnet release wire and form a circuit. Separation of the magnet and the magnet rest activates an alarm of the device and an audible alert is initiated in order to notify and remind a parent or caregiver of a child being present in a vehicle.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE DISCLOSURE

### Technical Field

Exemplary embodiment(s) of the present disclosure relate to alarm systems and, more particularly, to a specially designed alarm system to prevent leaving an unattended child in a vehicle.

### Prior Art

Child safety seats are required by law when transporting young children in motor vehicles. Typically, the child seat is securely positioned in a back seat of the vehicle and the child secured in the child seat via a child seat safety belt. These laws have been established and strictly enforced to protect children from injury when being transported in motor vehicles. However, there have been instances where children have been left behind in unattended vehicles due to various circumstances. Unfortunately, every year there are scenarios wherein a child is injured or killed as a result of being left in an unattended vehicle, and generally from heat.

There have been numerous approaches that have been implemented to prevent leaving a child behind in an unattended vehicle. For example, one approach activates an alarm when a child seat is buckled and when the car key is removed from the ignition. Another approach includes a warning system for warning when a child has been left in an infant seat within a vehicle and when the vehicle door is opened. These approaches have not been satisfactory in all respects. Therefore, a suitable alternative is desired.

Accordingly, a need remains for a reminder alarm system in order to overcome at least one of the above-noted shortcomings. The exemplary embodiment(s) satisfy such a need by a flower shaped child alarm system that is convenient and easy to use, lightweight yet durable in design, versatile in its applications, and designed to provide a reminder device and alarm system to prevent children from being left alone in an unattended vehicle.

### BRIEF DESCRIPTION OF THE SEVERAL VIEWS OF THE DRAWING

The novel features believed to be characteristic of the exemplary embodiment(s) are set forth with particularity in the appended claims. The disclosure itself, however, both as to its organization and method of operation, together with further objects and advantages thereof, may best be understood by reference to the following description taken in connection with the accompanying drawings in which:

The figures generally include various perspective/elevational view(s) showing a flower shaped child alarm system, in accordance with non-limiting exemplary embodiment(s) of the present disclosure.

FIG. 1 is a front view of a flower shaped child alarm system according to an embodiment of the present invention.

FIG. 2 is a side view illustrating the flower shaped child alarm system comprising a reminder alarm assembly according to an embodiment of the present invention.

FIG. 3 is a rear perspective view illustrating the flower shaped child alarm system according to an embodiment of the present invention.

FIG. 4 is a perspective view illustrating the flower shaped child alarm system during a mounted condition according to an embodiment of the present invention.

FIG. 5 is a perspective view illustrating the flower shaped child alarm system in a variety of environmental conditions according to an embodiment of the present invention.

### DETAILED DESCRIPTION OF THE DISCLOSURE

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment set forth herein. Rather, these embodiment(s) are provided so that this application will be thorough and complete, and will fully convey the true scope of the disclosure to those skilled in the art.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

References in the specification to “an exemplary embodiment”, “an embodiment”, “a preferred embodiment”, “an alternative embodiment” and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

A non-limiting exemplary embodiment(s) of the present disclosure is referred to generally in the figures and is intended to provide a flower shaped child alarm system. It should be understood that the exemplary embodiment(s) may be used to provide a reminder device for preventing children from being left alone in an unattended vehicle, and should not be limited to any particular flower shaped child alarm system described herein.

### GLOSSARY FOR A FLOWER SHAPED CHILD ALARM SYSTEM

1. Suction cup
2. Speaker
3. Stem
4. Hook
5. Flower petals
6. Magnet
7. Magnet rest
8. Housing of electronics and battery for alarm and speaker
9. Magnet release wire
10. Mount
11. Leaves

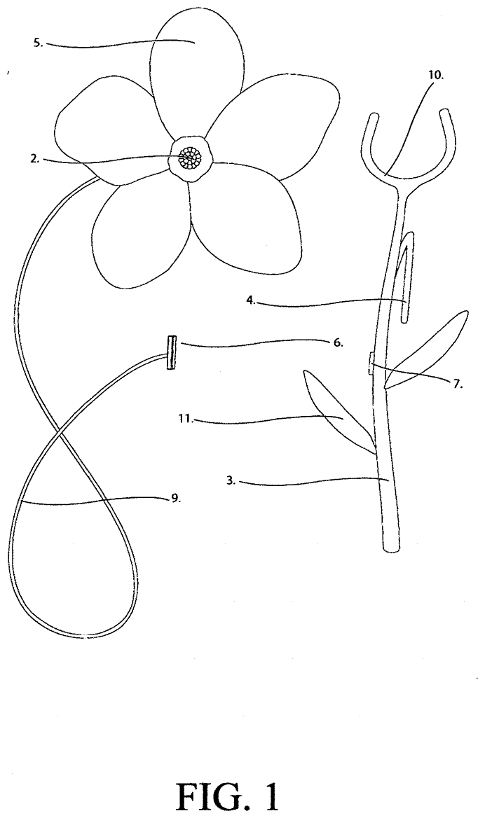

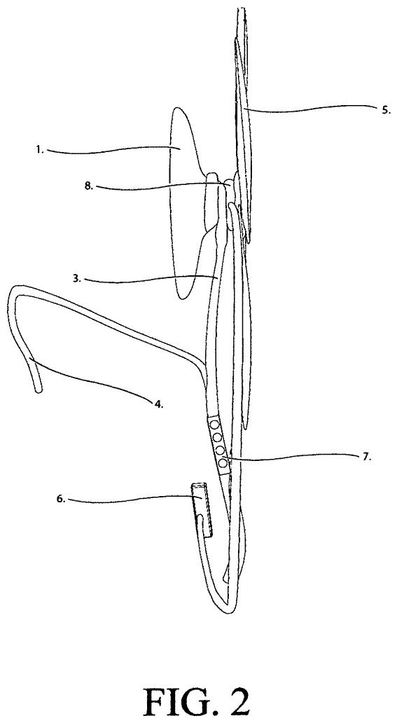

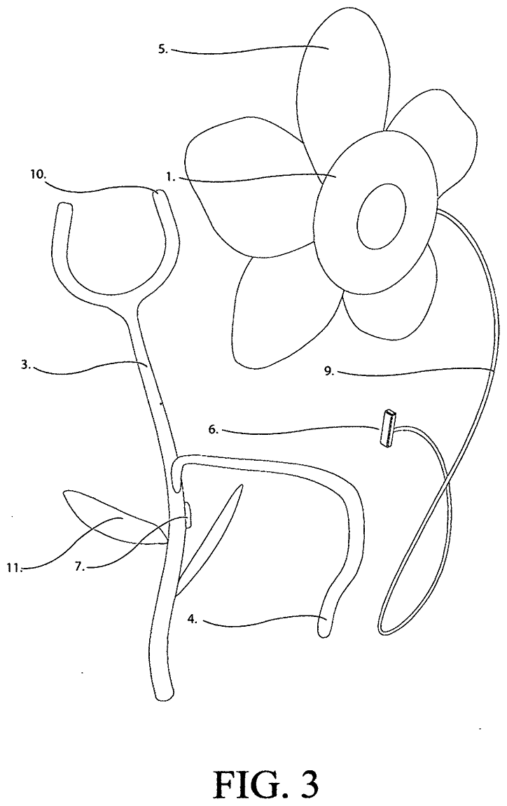

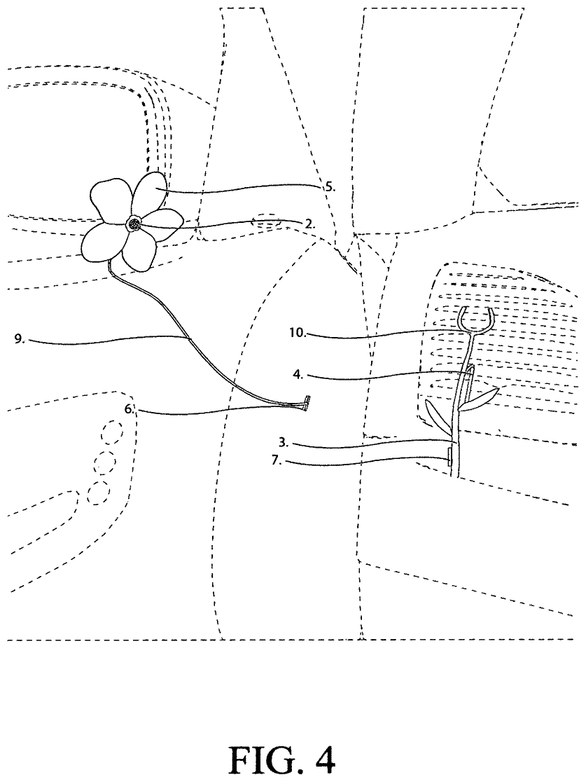

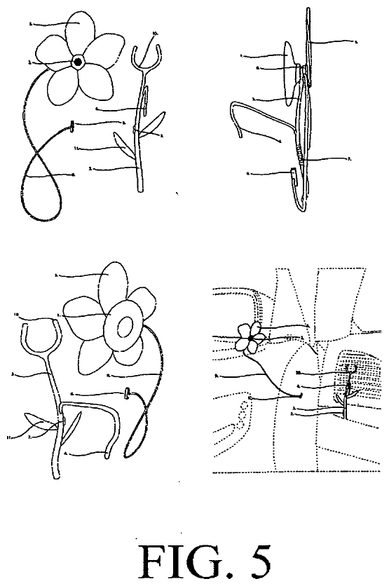

Referring to the FIGS. 1-5 in general, in a non-limiting exemplary embodiment(s), the flower shaped child alarm system is shown. The flower shaped child alarm system includes a reminder alarm assembly consisting of a flower head section and a holster member for supporting the flower head section between uses. The flower head section and the holster member are configured to work in combination and provide an alarm system for preventing children from being left alone in a vehicle.

More specifically, the flower head section includes flower petals 5, a speaker 2 positioned at a center portion of the flower petals 5, and a magnet release wire 9 extending therefrom. The speaker 2 of the flower head section is configured to output an audible alert when activated. The magnet release wire 9 comprises a magnet 6 configured to releasably connect to a magnet rest 7 located on the holster member. Connection of the magnet 6 and the magnet rest 7 form a closed circuit. Separation of the magnet 6 and the magnet rest 7 activates an alarm of the device and the audible alert is initiated in order to notify and remind a parent or caregiver of a child being present in a vehicle. The flower head section further includes a suction cup 1 for securing the flower head section to a driver's side vehicle window. Electronics and a battery power source may be housed within a housing 8 portion of the flower head section.

As show in the figures, the holster member of the reminder alarm assembly is formed in a flower stem configuration including a stem 3 and decorative leaves 11 extending therefrom. The holster member features a mount 10 for receiving the flower head section and supporting the flower head section between uses. Additionally, the holster member includes a hook 4 which may be inserted into an air vent of a vehicle and support the holster member and flower head section thereon.

A method of using the flower shaped child alarm system is as follows: a driver-caregiver enters a vehicle and removes the flower head section and secures it to a driver's side window using the suction cup 1 positioned on a rear portion of the flower head section. At this point, the magnet 6 and the magnet rest 7 are coupled forming a connection. Upon arrival at a destination, when a vehicle door is opened, the connection between the magnet 6 and the magnet rest 7 is disrupted thereby activating the alarm of the device and the audible alert is played through the speaker 2 of the flower head section. A parent or caregiver is then notified and reminded to remove a child from the vehicle.

There has thus been outlined, rather broadly, the more important features of the disclosure in order that the detailed description thereof that follows may be better understood, and in order that the present contribution to the art may be better appreciated.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the disclosure of the application, nor is it intended to be limiting as to the scope of the disclosure in any way.

While the disclosure has been described with respect to certain specific embodiment(s), it will be appreciated that many modifications and changes may be made by those skilled in the art without departing from the spirit of the disclosure. It is intended, therefore, by the description hereinabove to cover all such modifications and changes as fall within the true spirit and scope of the disclosure. In particular, with respect to the above description, it is to be realized that the optimum dimensional relationships for the parts of the exemplary embodiment(s) may include variations in size, materials, shape, form, function and manner of operation.

What is claimed as new and what is desired to secure by Letters Patent of the United States is:

1. A flower shaped child alarm system, said flower shaped child alarm system comprising: a reminder alarm assembly including
a flower head section comprising flower petals, a speaker at a center portion of said flower petals, a suction cup, and a magnet release wire extending therefrom and including a magnet, and
a holster member having a hook for mounting to an air vent of a vehicle and supporting said flower head section between uses, and a magnet rest configured to removably attach to said magnet and form a circuit;
wherein separation of said magnet and said magnet rest activates an alarm of said reminder alarm assembly and an audible alert is initiated in order to notify and remind a caregiver of a child being present in a vehicle; and
wherein said flower head section and said holster member are configured to work in combination and provide an alarm system for preventing said child from being left unattended in said vehicle.
